(19) United States
(12) Patent Application Publication
(10) Pub. No.: US 2019/0185726 A1
(43) Pub. Date: Jun. 20, 2019

(54) LIPID-BASED DUST CONTROL PRODUCTS

(71) Applicant: McTron Technologies, LLC, Greenville, SC (US)

(72) Inventor: Andrew McDaniel, Greenville, SC (US)

(73) Assignee: McTron Technologies, LLC, Greenville, SC (US)

(21) Appl. No.: 16/219,447

(22) Filed: Dec. 13, 2018

Related U.S. Application Data
(60) Provisional application No. 62/599,094, filed on Dec. 15, 2017.

(51) Int. Cl. C09K 3/22; B05D 1/02; E21F 5/02

(52) U.S. Cl. CPC C09K 3/22; E21F 5/02; B05D 1/02

(57) ABSTRACT

A dust control product includes a lipid, a second component that corresponds to a surfactant and a dilutant. The second component and lipid are processed together to create a lipid emulsion in which the second component acts as a protective colloid. Lipids include animal fats like tallow, lard, chicken fat, and/or butter, as well as plant-based fats like palm oil, coconut oil, avocado oil, cocoa butter, vegetable oil, soybean oil, trans fats, and peanut oil. The second component may correspond to one or more of polyethylene glycol, a polyethylene glycol derivative, a sugar alcohol, a sugar alcohol derivative or another alcohol or alcohol derivative. The dilutant may correspond to water, a saline solution, glycol, glycerin or a combination thereof. The dust control product may include a third component, including a preservative, an extender and/or a humectant.

### REFERENCE

This application claims priority to U.S. Provisional Application No. 62/599,094, filed on Dec. 15, 2017, the entire contents of which are incorporated herein by reference.

### BACKGROUND

Dusty conditions are problematic because they, for instance, limit visibility, can irritate individuals who breathe in the dusty conditions, may cause environmental impacts, etc. Dusty conditions arise from a variety of sources. For instance, unpaved roads (e.g. dirt roads, gravel roads, roads that are not paved with asphalt, concrete, etc.) have a tendency to become dusty as the roads dry out and may also have an increased tendency to “washboard” (i.e. ripple and/or become bumpy due to traversing the roads in dry conditions) in the dry, dusty conditions, which is harmful for vehicles traversing the road. Dusty conditions occur most frequently in areas that are prone to hot, dry conditions, which frequently occur in the summer.

Tests have been created to determine when conditions are too dry. For example, the optimal moisture content for an unpaved road is generally established by the Proctor compaction test. When the Proctor compaction test is used, unpaved roads have an optimal moisture content ranging from about 7% to about 10%. This range allows the soil to be compacted without becoming brittle, washboarding and/or breaking apart. Roads that have this optimal moisture composition are not dusty, but also are not so moist that the roads soften and/or deteriorate (e.g. creating washouts, potholes, etc.). When conditions become hot and dry, unpaved roads dry out have a moisture content that is less than ideal, and, as a result, the roads become dusty. To combat this problem, on would think that the unpaved roads should be sprayed with water. However, when the unpaved roads are sprayed with water, the dust problem returns as soon as the roads dry, and the dust problem may even become worse as a result of this additional cycle of wetting and drying.

To treat the dusty conditions, roads were traditionally sprayed with petroleum-based products, including diesel fuel, new and/or used motor oil, lubricating oils (e.g. crankcase oils, etc.), etc. However, these petroleum-based products are not environmentally friendly, so using these products has been prohibited by law in most areas. As an alternative, many individuals dissolve salts (e.g. calcium chloride, etc.) in water and/or other dilutant and apply the solution to the roads. While these salt-based sprays are better for the environment than petroleum-based products, the salt-based products do not last as long as petroleum based products, are corrosive to vehicles and other metal equipment that travel on the roads, and are not completely environmentally friendly because, for instance, these salt-based products raise the chlorine levels in lakes, streams and other waterways. Additionally, unlike petroleum-based products, salt-based products may draw water into the road, which may lead to deterioration of the road. What is needed is an environmentally friendly alternative to petroleum-based and salt-based products that limits and/or prevents dusty conditions and may also limit “washboarding” due to the dry condition of the road.

Dusty conditions are present on areas other than unpaved roads. For example, areas in and around mines (e.g. gypsum mines, coal mines, etc.) also become dusty when exposed to hot, dry conditions. Additionally, the cargo (e.g. gypsum, coal, etc.) that has been mined from these locations is frequently placed in large containers (e.g. open railroad cars, etc.), and this cargo may become dusty when exposed to hot, dry conditions, causing dust to exit the large container. Dusty conditions associated with areas around mines, as well as the cargo from the mines, have been treated using the petroleum-based and salt-based products used on unpaved roads, which have the same drawbacks as discussed above. There are many other dust-prone areas that could benefit from environmentally friendly alternatives to traditional dust control products, including: land development sites, construction sites, event lots, defense compounds, military operation sites, dusty slopes and berms, unpaved parking lots, helipads, etc. Accordingly, what is needed is an effective, environmentally friendly alternative to petroleum-based and salt-based products that limits and/or prevents dusty conditions associated with areas around roads, mines, cargo and other dust-prone areas.

In one example implementation, described herein, a dust control product includes a lipid, a second component that corresponds to a surfactant, the lipid and second component being processed together to create a lipid emulsion in which the second component acts as a protective colloid. The dust control product further includes a dilutant. The lipid is formed from animal fat, a plant-based fat or more than one of the foregoing. The animal fat may be tallow, lard, chicken fat, butter or any combination of the foregoing. The plant-based fat may corresponds to palm oil, coconut oil, avocado oil, cocoa butter, vegetable oil, soybean oil, trans fats, or peanut oil. The animal fat may be rendered. The lipid may be hydrogenated or not hydrogenated. The second component may correspond to one or more of polyethylene glycol, a polyethylene glycol derivative, a sugar alcohol, a sugar alcohol derivative or another alcohol or alcohol derivative. The dilutant may correspond to water, a saline solution, glycol, glycerin or a combination thereof. The dust control product may include a third component that corresponds to one or more of a preservative, an extender or a humectant.

In another example implementation, described herein, a method for treating a substrate to prevent dusty conditions on the substrate. The method may include providing a dust control product that is formed from at least a lipid, a second component and a dilutant. The second component and lipid are processed together to create a lipid emulsion. The second component corresponds to a surfactant. The method may further include applying the dust control product to the substrate to prevent the dusty conditions. The method may further include mixing the lipid emulsion formed from the lipid and the second component with the dilutant to create the dust control product. Applying the dust control product may corresponds to spraying the dust control product from a spray truck, a hand sprayer, a broadcast sprayer or a hose. The dilutant may be water.

In another example implementation, described herein, a method for manufacturing a dust control product, including providing a lipid and a second component that corresponds to a surfactant. The method further includes processing the lipid with the second component to create a lipid emulsion. Processing the lipid with the second component may correspond to a homogenization process where a mixture of the lipid and second component are pressurized and passed through one or more orifices. The lipid may be heated to a temperature above a melting point of the lipid prior to processing the lipid with the second component. The method may further include providing a dilutant and mixing the lipid emulsion with the dilutant. The second component may correspond to a sugar alcohol, a sugar alcohol derivative, polyethylene glycol, or a polyethylene glycol derivative. The lipid may correspond to tallow or lard.

### BRIEF DESCRIPTION OF THE DRAWINGS

FIG. 1 is a diagram of an example environment in which the systems, methods, mixtures, and/or technologies, described herein, may be implemented;

FIG. 2 is a flow chart of an example process for creating and using a lipid-based dust control product in a manner similar to that described herein.

### DETAILED DESCRIPTION

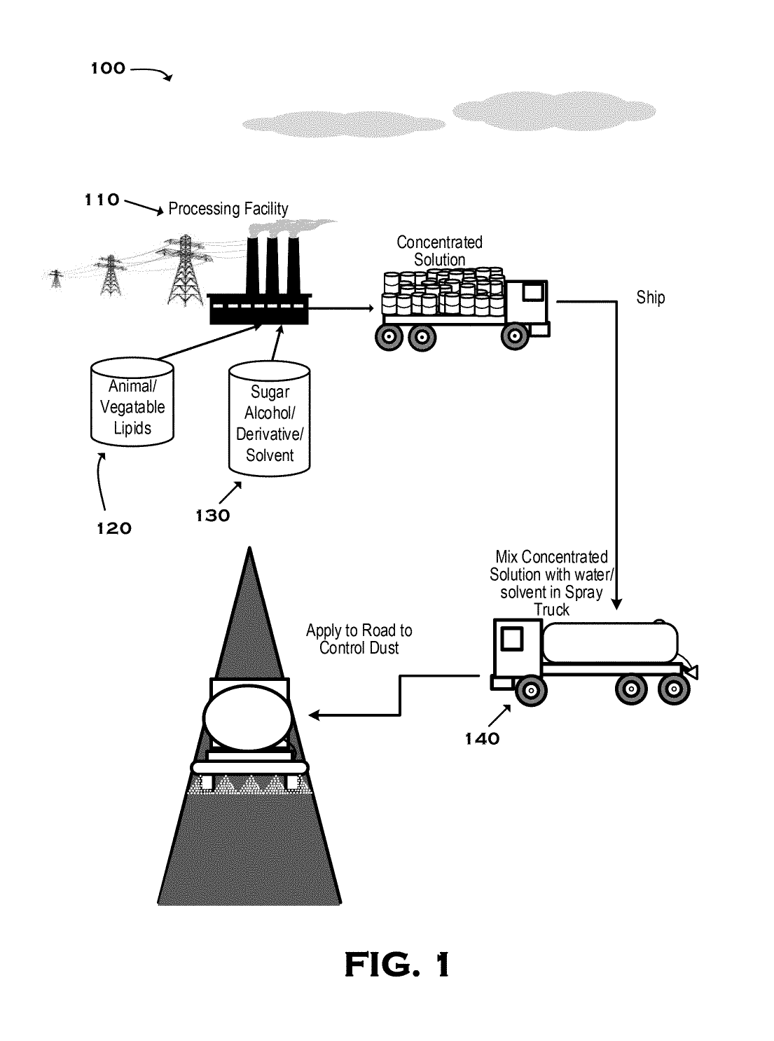

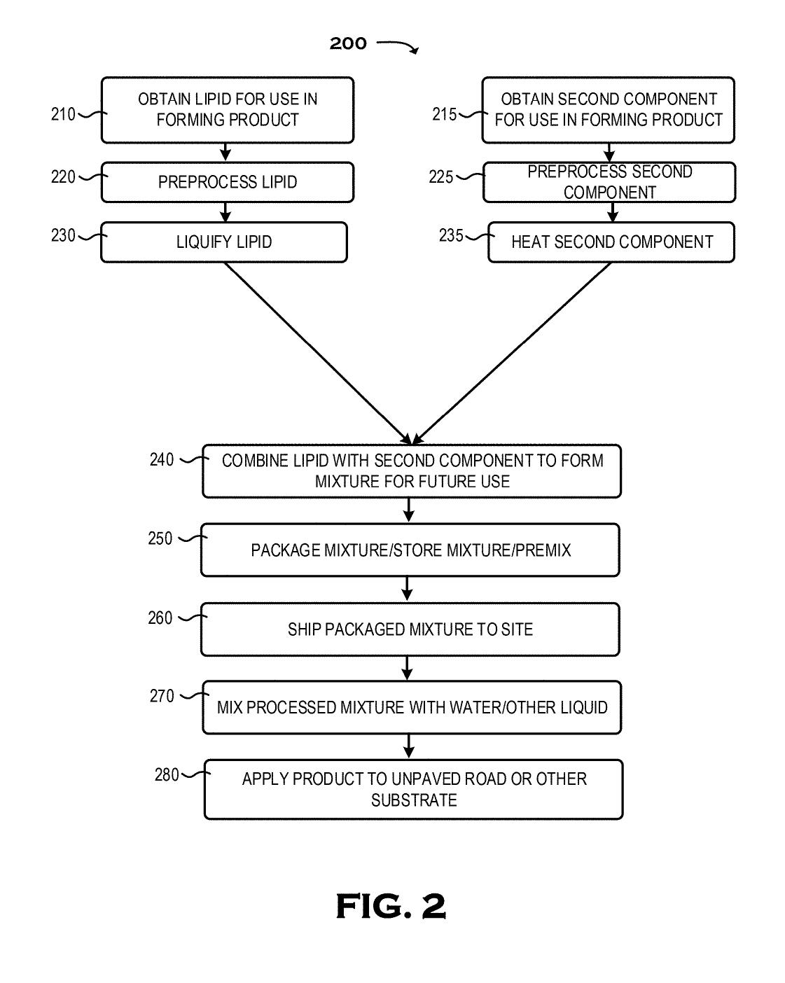

FIGS. 1 and 2 are attached thereto and incorporated herein by this reference. The following detailed description refers to the accompanying FIGS. 1 and 2. The same reference numbers in different figures may identify the same or similar elements. There may be additional components/blocks etc., fewer components/blocks, different components/blocks, or differently arranged components/blocks than illustrated in FIGS. 1 and 2. In some implementations, the functions of one of the components/blocks of FIGS. 1 and 2 may be performed by a different component/block. Systems, methods, combinations, and/or technologies (hereinafter, “methods and/or combinations”), described herein, may provide a lipid-based dust control product that may be applied to an unpaved road (e.g. a dirt road, gravel road, road that is not paved with asphalt, concrete, etc.) to limit and/or prevent dusty conditions associated with the unpaved roads. Additionally, or alternatively, the methods and/or combinations may provide a lipid-based dust control product that may be applied to treat other dusty conditions, such as those encountered around mines (e.g. gypsum mines, coal mines, etc.) and associated with the cargo (e.g. gypsum, coal, etc.) that is hauled away from the mines.

Unlike petroleum-based products and salt-based products, the lipid-based dust control products of the present invention may be environmentally friendly and/or safe. Unlike salt-based products, the lipid-based products of the present invention may not draw water into the substrate on which the dust-control product is applied but, instead, may limit and/or prevent water from entering/seeping into the substrate and/or have a hydrophobic quality, both of which are similar to petroleum-based products. Drawing water into the substrate may lead to other issues associated with higher water content (e.g. rutting, washout, etc.). Further, unlike salt-based products, the lipid-based products of the present invention may not be corrosive to cars, trucks, trailers, etc. that come in contact with the product. Further, the lipid-based products of the present invention may control dusty conditions and/or last longer than salt-based products.

The lipid-based dust control product may include a lipid emulsion comprising a first component that corresponds to a lipid and a second component that corresponds to a surfactant that acts as a protective colloid around the first component to make the lipid emulsion readily miscible in a dilutant, such as water, to create the dust control product. Because the lipid emulsion is miscible with water, the lipid may be evenly distributed when the dust control product is applied to a substrate. The dilutant may be added to the lipid emulsion at a rate that varies depending upon the intended use. The lipid may include, for example, animal fats (rendered or unrendered), like beef fat (or tallow), pig fat (lard), chicken fat, butter, etc. The lipid may also, or alternatively, include plant-based fats, like palm oil, coconut oil, avocado oil, cocoa butter, trans fats, etc. The lipid may be fully hydrogenated, partially hydrogenated, and/or not hydrogenated, etc. The lipid may include other fats/fat substitutes, and may be combination of more than one lipid. Because these lipids are derived from animals and/or plants, they may be more environmentally friendly than petroleum-based products and/or salt-based products. While any lipid may be used for the first component, the optimal lipids may have a melting point at or above room temperature. Higher melting point lipids may correspond to better dust control properties because, for instance, they have a decreased tendency (as compared to lower melting point lipids) to melt and/or separate from the dirt/soil/etc. of the road when applied to the road as further explained herein.

The second component may correspond to a surfactant that acts as a protective colloid around the first component/lipid to make the resulting combination miscible with a dilutant, such as water. The resulting combination includes very small droplets of the lipid that are evenly dispersed as a result of the second component, which allows the resulting combination to be easily mixed with the dilutant and results in the lipid being evenly applied to the substrate (because the lipid is evenly distributed in the dust control product). The second component may include, for instance, one or more sugar alcohols (e.g. sorbitol, xylitol, erythritol, maltitol, mannitol, isomalt, lactitol, etc.), sugar alcohol derivatives (e.g. sorbate, Polyoxyethylene Sorbitan Monooleate CAS# 9005-65-6, polysorbate 80, polysorbate 20, polysorbate 40, other derivatives of sorbitol, mannitol, or some other sugar alcohol, etc.) polyethylene glycol, polyethylene glycol derivatives (polyethylene glycol oleate, polyethylene glycol tallate, etc.) and/or another surfactant that may be mixed with the first component to produce a lipid emulsion (hereinafter referred to as a “lipid emulsion”) that may be stable enough (e.g. may not separate, settle, etc.) to be packaged and/or stored so that it may be transported for future use. Because the second component acts as a surfactant, the second component may lower the surface tension between the other components of the lipid-based dust control product (e.g. such as water/other dilutant that is used to dilute the lipid emulsion prior to application). The lipid emulsion may be in a liquid form at all temperatures associated with its use (e.g. when mixing the lipid emulsion with water, when spraying, between about 40 degrees Fahrenheit and up to maximum external temperatures of about 120 degrees Fahrenheit, etc.) so that the dust control product may be sprayed on an unpaved road without clogging spray nozzles due to solidifying of the product, or one or more of the components therein.

Prior to processing the first component with the second component to combine the two, the first component may be preprocessed. Preprocessing the first component may include removing non-lipids/impurities from the first component, such as by rendering (i.e. converting beef/mutton/pork fat and/or animal fats into tallow, etc.) straining, etc. Preprocessing may also, or alternatively, include one or more steps that may increase the melting point of the lipid, such as by hydrogenating (partially or fully—which may raise the melting point) the lipid. Prior to processing the first component with the second component to combine the two, the second component may be preprocessed. For instance, the second component may be converted into a derivative (e.g. a sugar alcohol derivative, a polyethylene glycol derivative, etc.).

Processing the first component with the second component to create the mixture/lipid emulsion may cause the two components to be combined in a way that allows the mixture to be packaged, stored, used and/or transported to be used as described herein. For example, and without limitation, the first component may be homogenized with the second component. Homogenizing the first component with the second component may allow the first component and second component to become uniformly distributed in a resulting combination, or lipid emulsion, that may prevent the components from separating out of the solution. The process by which the first component and the second component become uniformly distributed may first include heating the first component to a temperature above the melting point to liquefy the first component. The process may further include introducing the second component, which is in liquid form and may have been heated to a temperature above the melting point of the first component, to the first component and mixing the two together. The process may further include a homogenization process whereby, for instance, the two components are pressurized and then forced through one or more small orifices. Pressurizing the mixture and forcing it through one or more small orifices may create an emulsion of the two components. Creating an emulsion of the two components, which may be otherwise immiscible, may cause small particles of the first component to be evenly, or near evenly, dispersed in the second component in a way that resists separation of the two components, which may make the resulting mixture suitable for storage (e.g. storage at temperatures at or above 32 degrees Fahrenheit, storage at or above room temperature of about 60 degrees Fahrenheit, etc.), transport, and/or future use. Additionally, or alternatively, homogenizing the two components may result in a combination that remains in a liquid state at temperatures associated with using the product (e.g. the temperature associated with mixing the lipid emulsion with water, temperature of storage, etc.), which may allow the mixture to be easily mixed with water and/or another dilutant and the result to have the lipid evenly distributed in the product. The dust control product may then be applied to a substrate in a way that results in an even distribution of the lipid across the substrate. Processing the first component with the second component is not limited to the processes described herein. For instance, the first component and the second component may be blended and/or mixed together, such as with blenders, various emulsifiers, mixers, mills, extruders, etc.

The first component and the second component may be combined at any ratio to create the mixture or lipid emulsion. The amount of lipid applied to the dusty condition depends upon the rate at which the first component and second component are mixed together as well at the amount of water/other dilutant added to the lipid emulsion to form the lipid-based product. For example, the first component may comprise a major amount (above 50% by weight) of the lipid emulsion while the second component may comprise a minor amount (below 50% by weight) of the lipid emulsion. More ideally, the first component may comprise a greater amount, by weight, of the mixture, for instance, 70%, 80%, 90%, 95%, etc. In this embodiment, the first compound may act as the continuous phase and the second compound by act as the dispersed phase of a colloidal suspension formed from combining the first component with the second component. Alternatively, the second component may comprise a major amount while the first component comprises a minor amount of the mixture. Because the mixture may be mixed with water and/or another dilutant to form the dust control product, the ranges of amounts of these two components may vary to suit particular applications, lipid types, types of first component, types of second component, types of processes, intended use, etc.

After the first component is processed with the second component, the resulting lipid emulsion may be further processed to include a third component (as well as a fourth, fifth, etc.). The third component may include, for example, a pigment that may alter the color of the mixture. Additionally, or alternatively, the third component may correspond to a preservative, such as a chemical biocide that is typically used in the chemical products industry, that may preserve the integrity of the lipid emulsion and/or help keep the components from separating, etc. Additionally, or alternatively, the third component may include an extender or a humectant that may help preserve moisture in the substrate on which the product is applied, such as glycerine, urea, latex emulsions, calcium chloride, magnesium chloride salt solutions, starch containing solutions, etc. The third component may result in a lipid emulsion that is more stable than before the third component was added, have better properties (color, water properties, have a longer shelf life, etc.).

The lipid emulsion may be stored until needed for use. The lipid emulsion may be shipped to a location that may include a dusty condition. To treat the dusty condition, the lipid emulsion may be mixed with water and/or another dilutant to create a lipid-based dust control product (the “product”) to be applied to the road. For example, and not limitation, the lipid emulsion may be mixed with water in a mixing truck. Because the second component of the lipid emulsion is a surfactant, the lipid emulsion is miscible with water, resulting in an even distribution of the lipid in the product. The ratio of lipid emulsion to water may be determined based upon an application rate of the lipid. For instance, if the application rate corresponds to a high lipid content, then less water/dilutant may be used than when the application rate corresponds to a low lipid content. The application rate may be any rate that may result in a product that, when applied, limits and/or eliminates a dusty condition of any unpaved road. For example, the lipid emulsion may comprise a minor amount (e.g. less than 50% by weight, 10-30% by weight, 20% by weight, etc.) of the product. This may result in the lipid comprising, for example, about 5% to about 40% of the product, depending upon the amount of first component in the lipid emulsion. To mix the lipid emulsion and the water (or alternative dilutant), the two may be placed in a mixer and/or another container within which they may be mixed, such as a spray truck that operates in a circulate and/or recirculate mode. The product may be applied to the dusty condition using, for instance, a spray truck, a hand sprayer, broadcast sprayer, a hose, etc. In some instances, the lipid emulsion may be applied directly to a substrate (i.e. without mixing the lipid emulsion with a dilutant).

FIG. 1 is a diagram of an example environment 100 in which the methods and/or mixtures, described herein, may be implemented. As illustrated in FIG. 1, environment 100 may include a processing facility 110 that manufactures a lipid-based product by combining a first component 120 made from an animal-based or plant-based lipid (e.g. animal fats (rendered or unrendered), like beef fat (tallow), mutton (tallow) pig fat (lard), chicken fat, butter etc.; plant-based fats, like palm oil, coconut oil, avocado oil, trans fats, fully hydrogenated, partially hydrogenated, and/or not hydrogenated, other fats/fat substitutes) with a second component 130 that corresponds to a surfactant, for example one or more of the following: polyethylene glycol, polyethylene glycol derivatives (polyethylene glycol oleate, polyethylene glycol tallate, etc.), sugar alcohols (e.g. sorbitol, xylitol, erythritol, maltitol, mannitol, isomalt, lactitol, etc.), and/or sugar alcohol derivatives (e.g. sorbate, Polyoxyethylene Sorbitan Monooleate CAS# 9005-65-6, polysorbate 80, polysorbate 20, polysorbate 40, other derivatives of sorbitol, mannitol, or some other sugar alcohol, etc.). The processing facility may combine the first component with the second component in a way that permits the mixture to be stable (e.g. resists separation of the first component and second component) and/or creates a homogenous mixture that may be stored without separating for future use. Additionally, the processing facility may combine the first component with the second component to cause the resulting mixture to remain a liquid at a range of temperatures associated with storing, mixing and/or spraying the mixture. For example, the processing facility may combine the first component with the second component using a homogenization process. The homogenization process may begin by heating the first component to a temperature above the melting point of the first component but below the temperature at which the first component would smoke, become unstable, etc. The melting points/smoke points of the lipids described herein vary widely. For instance, the melting point of tallow is approximately 40-50 degrees Celsius (approximately 100 to 120 degrees Fahrenheit), depending upon the tallow used, and the smoke point is approximately 195 to 210 degrees Celsius (approximately 385 to 410 degrees Fahrenheit). For example, the lipid may be heated to a temperature far enough above the melting point that the lipid does not solidify when it is mixed with the second component. It may be most efficient to limit heating the lipid beyond the melting point as much as possible, such as to avoid unnecessary costs associated with heating the lipid beyond the melting point, etc. Heating the first component may liquefy the first component, which may facilitate combining the first component with the second component. Additionally, or alternatively, the second component may be heated to a temperature at or above the melting point of the first component before combining the first component with the second component, which may maintain the first component in liquid form when the two are mixed/combined prior to homogenization.

Processing the first component with the second component may include combining the two components (i.e. introducing the second component to the first component, etc.), such as in a reservoir, and mixing the combined components to mix the components together. Additionally, or alternatively, processing the first component with the second component may include homogenizing the mixture, which may include pressuring the mixture and passing the mixture through, for instance, a homogenization valve. Processing the first component with the second component may prevent separation of the first component and second component (e.g. during storage, etc.). Optimally, processing the first component with the second component will result in an emulsion/homogeneous mixture in which fine particles of the first component are evenly dispersed in the second component (or vice versa), which may prevent the lipid emulsion from separating during storage. The resulting lipid emulsion may have a lower melting point than the lipid and may remain a liquid at all desired temperatures to which the mixture is exposed, and/or may be easily mixed with water, or another liquid, prior to being applied to a substrate (e.g. an unpaved road, an area around a mine, a cargo load of gypsum, coal, etc.).

The lipid emulsion (comprising the first and second components, and any third components, fourth components, etc.) may be transported to a location that may include a spray truck, broadcast sprayer, hand sprayers (knapsack sprayers, turf sprayers, etc.) or any other type of spraying equipment that may be used to apply the lipid-based product to a substrate. The lipid emulsion may be combined with water and/or another dilutant in which the lipid emulsion may be uniformly distributed and applied to an unpaved road by the spray truck, hand sprayer, etc. Combining the lipid emulsion with water (e.g. water from any water source, including lakes, wells, rain, etc.) may create an environmentally friendly, lipid-based dust control product. The product may be mixed using, for instance, a mixer, a recirculation pump, etc. so that the components of the product are uniformly applied to the chosen substrate. The product may be formed using any range of amounts of the lipid emulsion and water/other dilutant depending upon, for instance, the amount of lipid in the mixture and/or the environmental conditions associated with the substrate to be treated. For example, but not limitation, substrates located in humid areas may be better treated using a product with a higher lipid content/lower water content than substrates located in arid areas. Additionally, or alternatively, some substrates may be better treated using a low lipid content product that is applied in several coats. The range of amounts of first components, second components, third components, fourth components, water/other dilutants in the dust control product may vary widely depending upon the needs of the user.

The lipid-based product may limit dust and/or other conditions associated with a dry/dusty substrate, like washboarding. Unlike salt-based products, the lipid-based product does not draw water into the unpaved road. Lipids are not currently used for dust control because, for instance, they are not normally in a usable form (e.g. too waxy and/or solid at temperatures associated with applying a product to a substrate, etc.) associated with dust-control products. Accordingly, the lipids in the dust control products described herein are processed to so that they are usable, easy to handle, can be mixed with water/another liquid, applied to a substrate, etc. to limit and/or prevent dusty conditions.

FIG. 2 is a flow chart of an example process 200 for creating the lipid-based dust control product in a manner similar to that described herein. As illustrated in FIG. 2, process 200 may include obtaining a first component that corresponds to a lipid (e g animal fats (rendered or unrendered), like beef fat (tallow), mutton (tallow) pig fat (lard), chicken fat, butter etc.; plant-based fats, like palm oil, coconut oil, avocado oil, trans fats, fully hydrogenated, partially hydrogenated, and/or not hydrogenated, etc.; and/or other fats/fat substitutes) (BLOCK 210). Process 200 may further include obtaining a second component that corresponds to one or more of, for instance, polyethylene glycol, a polyethylene glycol derivative, sugar alcohol (e.g. sorbitol, xylitol, erythritol, maltitol, mannitol, isomalt, lactitol, etc.), sugar alcohol derivatives (e.g. sorbate, Polyoxyethylene Sorbitan Monooleate CAS# 9005-65-6, polysorbate 80, polysorbate 20, polysorbate 40, other derivatives of sorbitol, mannitol, or some other sugar alcohol, etc.) or another surfactant appropriate for the chosen lipid.

Process 200 may further include preprocessing the lipid (BLOCK 220). Preprocessing the lipid may include, for instance, rendering the lipid to remove any impurities (e.g. non lipids, proteins, cartilage, etc.). Additionally, or alternatively, preprocessing the lipid may include, for instance, hydrogenating the lipid (e.g. treating the lipid with hydrogen to raise the melting point of the lipid). Hydrogenating the lipid may raise the melting point of the lipid. Higher melting point lipids may be associated with better dust control and/or longer service life because higher melting points may not melt and/or separate from the substrate during warm days or may melt/separate from the substrate at a slower rate than lower melting point lipids. Process 200 may further include preprocessing the second component (BLOCK 225). Preprocessing the second component may include, for instance, creating a derivative from sugar alcohol (i.e. creating a sugar alcohol derivative), creating a derivative of polyethylene glycol, combining two or more second components, etc.

Process 200 may further include liquefying the lipid (BLOCK 230) by raising the temperature of the lipid to a temperature above the melting point of the lipid but below the temperature at which the lipid becomes unstable (e.g. smoke point, etc.). Process 200 may further include heating the second component (BLOCK 235) to a temperature at or near the melting point of the lipid but below the point at which the lipid becomes unstable. Heating the second component may prevent the first component from solidifying when the first component and second component are combined.

Process 200 may further include combining the lipid with a second component to form a lipid emulsion for future use (BLOCK 240). The mixture may be formed using a variety of processes, including, for instance, homogenizing the mixture. Homogenizing the mixture may create an emulsion of the lipid in the second component (or the second component in the lipid, depending upon the ratio of components) by pressuring the mixture and passing the mixture through, for instance, a homogenization valve. Processing the first component with the second component in this fashion may prevent separation of the components in the mixture (e.g. during storage, etc.) and may cause the first component and the second component to be evenly dispersed in a solution. Additionally, or alternatively, processing the first component with the second component in this fashion may cause the lipid to have a fine particle size and/or may cause the solution to remain liquid at all temperatures to which the solution may be exposed when storing, preparing and using the product as described herein. Having a fine particle size may facilitate spraying the lipid-based product because, for example, the particle size may easily pass through the orifice of a sprayer used to apply the product. While BLOCK 240 is described herein as homogenization, the lipid may be processed with the second component in a variety of ways, including mixing, emulsifying, blending, etc.

When combining the first component with the second component, various ranges of amounts may be used for each component. For example, and not limitation, the lipid may comprise a major amount of the lipid emulsion (greater than 50% by weight of the mixture, preferably greater than 70%, more preferably greater than 80%, 90%, etc.) The amount of the second component contained in the lipid emulsion may correspond to the amount needed to maintain the melting point of the mixture at or below the minimum temperature associated with using the product, storing the product and/or the temperature of the water/other liquid to which the mixture is added prior to spraying. In a non-limiting example, the first component may correspond to beef tallow, which may comprise about 20-90% of the lipid emulsion. The first component may be heated to a temperature above the melting point (e.g. above 120 degrees Fahrenheit, 140 degrees Farenheit, etc.), may be strained, etc. The second component may correspond to any type of surfactant that may allow the lipid to be stored and applied in liquid form, including, but not limited to, those second components described herein. Ideally, the second component is an environmentally friendly product, such that applying the product to unpaved roads and other outdoor areas does not harm the local environment. The two components may be homogenized together (with or without additional components) to create a lipid emulsion that is stable (i.e. the components do not separate, resist settling, remain evenly suspended, etc.), that has fine particle size and that remains in liquid form in all operating conditions (storage, combining with water or another liquid, spraying etc.). Additionally, or alternatively, lipids and second component(s) may be combined at any other range of amounts (e.g. by percentage 60/40, 70/30, 80/20, 90/10 etc.). One or more types of lipids and one or more types of second components may be used to create the lipid emulsion. The ranges of amounts of each component may depend upon the lipids and/or second components used to create the lipid emulsion, the conditions to which the lipid emulsion will be exposed, etc. Additionally, or alternatively, the ranges of amounts may depend upon the process used to create the mixture, the desired melting point/separation point of the lipid emulsion, the effectiveness of the lipid emulsion, the desired combination rate of water/dilutant to lipid emulsion used in the product, the desired viscosity of the lipid emulsion/product, etc. The present disclosure is intended to capture all of the ranges of amounts described herein. The lipid emulsion may be stable (i.e. may not separate) and may be easily mixed with/miscible with water and/or another dilutant. In one embodiment, the dust control product that is applied to treat an unpaved road or other substrate consists of a lipid, a second component and water.

After combining the lipid with the second component (and any desired third components) the lipid emulsion may be packaged and stored (BLOCK 250) as a concentrated product (i.e. it is mixed with water or another dilutant before use). In a non-limiting example, the lipid emulsion may be packaged (e.g., by packing into drums, bins, sealed containers etc.) for storage and sale. Additionally, or alternatively, the lipid emulsion may be combined with water and/or another liquid (at a rate of, for example, 5-40% mixture, 60-95% water, etc. as well as potentially other components, like the third components discussed herein) and packaged as a premixed or “ready-to-use” product, which may be ready to apply upon shaking, agitating and/or mixing, etc. the product or, alternatively, applied directly without shaking, agitating and/or mixing the product. The packaged lipid emulsion and/or ready-to-use product may be stored (e.g., in a warehouse, distribution center, outdoor storage area, etc.) and offered on the market for sale for use in preventing dusty conditions (such as on unpaved roads, etc.). The packaged product may be shipped to a site where it is used to treat a dusty condition (BLOCK 260). Additionally, or alternatively, the packaged mixture may be shipped (e.g., by train, truck, ship, etc.) to another location for storage, sale, use, mixing with water, etc.

If the packaged product is the lipid emulsion (i.e. has not been premixed), the lipid emulsion may be mixed with water and/or another liquid to dilute the lipid emulsion prior to applying it to the dusty condition, such as the unpaved road (Block 270). The lipid emulsion may comprise any range of amounts of the product, for example, 5% to 40% by weight, 10% to 30% by weight, 15% to 25%, etc., while water (or an alternative) may comprise the remaining portion of the product. The range of amounts of the percentage of the concentrated product in the final product may vary depending upon the environmental conditions, the number of “coats” used by end users, etc. Additionally, or alternatively, additional components may be added to the lipid emulsion/product. The product may be mixed, stirred, agitated, circulated, etc. to uniformly combine the lipid emulsion and the water/other liquid so that the lipid may be evenly dispersed on a dusty condition. In one application, the lipid emulsion is combined with water in a spraying truck, and the recirculation pump of the spraying truck is run to combine the lipid emulsion with the water to form the product. The product may be applied to any substrate by using, for instance, a spray truck (as depicted in FIG. 1), a hand sprayer, a broadcast sprayer, a hose, etc.

The lipid-based dust control product of the present disclosure has many other uses than those described above. For instance, the lipid emulsion may be mixed with liquids other than, or in addition to, water; for instance, the lipid emulsion may be mixed with a saline solution (a salt dissolved in water), glycol, glycerin, and/or another liquid. This product may be used to treat any substrate, including those described herein as well as, for example, a mineral (e.g. coal, etc.) as the mineral is being transported from conveyors to be shipped. The lipid based dust control product may be sprayed on the mineral as it falls from conveyors (e.g. conveyor belts, conveyor bins, etc.) into cargo bins (e.g. trucks, trailers, etc.) in which the minerals will be transported from the mine. While water may be combined with the lipid emulsion for this application, other products, like glycerin, glycols, and saline solutions, may be preferred as these products may lower the freezing point of the resulting lipid-based dust control product. Lowering the freezing point of the dust control product may prevent the treated minerals from sticking to the cargo bin within which they are placed as the product freezes (i.e. on days when the temperature to which the mineral is exposed is below the freezing point of the dust control product). The product may be sprayed on the minerals using one or more of the spraying devices referenced herein. Additionally, or alternatively, the product may pass through a foam pump and/or foam sprayer, which may convert the product into a foam to be applied to the minerals. Converting the product into foam, rather than a liquid, may reduce the droplet size of the product applied to the mineral, which may increase the coverage of the product by increasing the amount of surface area over which a volume of the product may be used.

In addition, the lipid emulsion may be used without mixing it with water and/or another liquid. For instance, the lipid emulsion may be applied directly to particulates (e.g. animal feed, grains, particulate fertilizers, etc.) to limit the dust of these particulate materials. Applying the lipid emulsion to these particulate materials may also prevent the individual particles of the particulate from sticking together. Prior to applying the lipid emulsion to the particulate, the lipid emulsion may be heated, which may make the lipid emulsion easier to spray than when the lipid emulsion is at a lower temperature. Water and/or another solution may be added to the lipid emulsion prior to spraying the particulate; however, it may be ideal to limit and/or eliminate water/other liquids in order to limit the stickiness of the particles. In this embodiment, the lipid emulsion may be comprised of a majority of the first component (i.e. the lipid is more than 50% of the lipid emulsion, preferably more than 70% of the lipid emulsion, more ideally more than 80% of the lipid emulsion). The lipid emulsion may be made from food grade components in this embodiment to make the particulate safe for animal and/or human consumption. Additionally, this embodiment may add nutritional/caloric value to the particulate to which it is applied.

The foregoing description provides illustration and description, but is not intended to be exhaustive or to limit the implementations to the precise form disclosed. Modifications and variations are possible in light of the above disclosure or may be acquired from practice of the embodiments.

While series of blocks have been described with regard to FIG. 2, the order and/or timing of the blocks is not intended to be limiting and may be modified in other implementations. Further, non-dependent blocks may be performed in parallel, concurrently, substantially concurrently, and/or in a different order. Additionally, or alternatively, in other implementations, the processes described with regard to FIG. 2 may include additional elements/blocks, less elements/blocks, modified elements/blocks, and/or different elements/blocks than shown in FIG. 2.

It will be apparent that technologies and/or techniques, as described above, may be implemented in many different forms. The actual or specialized hardware used to create/apply the products should not be construed to limit the embodiments taught herein—it being understood that hardware can be designed to implement different embodiments described herein. For example, and not limitation, various forms of homogenization/emulsifying/mixing equipment may be substituted for one another to combine the components/components/mixtures described herein. Further, sprayers may be replaced by other applicators.

It should be emphasized that the terms “comprises”/“comprising” when used in this specification are taken to specify the presence of stated features, integers, steps or components but does not preclude the presence or addition of one or more other features, integers, steps, components or groups thereof.

Even though particular combinations of features are recited in the claims and/or disclosed in the specification, these combinations are not intended to limit the disclosure of the embodiments. In fact, many of these features may be combined in ways not specifically recited in the claims and/or disclosed in the specification. No element, act, or instruction used in the present application should be construed as critical or essential to the embodiments unless explicitly described as such. Also, as used herein, the article “a” and “an” are intended to include one or more items and may be used interchangeably with “one” or “more.” Where only one item is intended, the term “one” or similar language is used. Further, the phrase “based on” is intended to mean “based, at least in part, on” unless explicitly stated otherwise.

What is claimed is:

1. A dust control product comprising:
a lipid;
a second component that corresponds to a surfactant, the lipid and the second component being processed together to create a lipid emulsion in which the second component acts as a protective colloid; and
a dilutant.

2. The dust control product of claim 1, where the lipid is formed from one or more of an animal fat or a plant-based fat.

3. The dust control product of claim 2, where the animal fat corresponds to one or more of tallow, lard, chicken fat or butter.

4. The dust control product of claim 2, where the plant-based fat corresponds to palm oil, coconut oil, avocado oil, cocoa butter, vegetable oil, soybean oil, trans fats, or peanut oil.

5. The dust control product of claim 2 where the animal fat is rendered.

6. The dust control product of claim 2, where the lipid is hydrogenated.

7. The dust control product of claim 2, where the lipid is not hydrogenated.

8. The dust control product of claim 1, where the second component corresponds to one or more of polyethylene glycol, a polyethylene glycol derivative, a sugar alcohol, a sugar alcohol derivative or another alcohol or alcohol derivative.

9. The dust control product of claim 1 further including a dilutant that corresponds to water, a saline solution, glycol, glycerin or a combination thereof.

10. The dust control product of claim 1 further including a third component that corresponds to one or more of a preservative, an extender or a humectant.

11. A method for treating a substrate to prevent dusty conditions on the substrate, the method comprising:
providing a dust control product formed from at least a lipid, a second component and a dilutant,
the second component and lipid being processed together to create a lipid emulsion, the second component corresponding to a surfactant;
applying the dust control product to the substrate to prevent the dusty conditions.

12. The method of claim 11 further including mixing the lipid emulsion formed from the lipid and the second component with the dilutant to create the dust control product.

13. The method of claim 11, where applying the dust control product corresponds to spraying the dust control product from a spray truck, a hand sprayer, a broadcast sprayer or a hose.

14. The method of claim 11, where the dilutant is water.

15. A method for manufacturing a dust control product, the method comprising:
providing a lipid;
providing a second component that corresponds to a surfactant; and
processing the lipid with the second component to create a lipid emulsion.

16. The method of claim 15, where processing the lipid with the second component corresponds to a homogenization process whereby a mixture of the lipid and second component are pressurized and passed through one or more orifices.

17. The method of claim 15, where the lipid is heated to a temperature above a melting point of the lipid prior to processing the lipid with the second component.

18. The method of claim 15, further comprising:
providing a dilutant; and
mixing the lipid emulsion with the dilutant.

19. The method of claim 15, where the second component corresponds to a sugar alcohol, a sugar alcohol derivative, polyethylene glycol, or a polyethylene glycol derivative.

20. The method of claim 15, where the lipid corresponds to tallow or lard.
